(19) United States
(12) Patent Application Publication
(10) Pub. No.: US 2010/0143565 A1
(43) Pub. Date: Jun. 10, 2010

(54) Chilled Ingredient for Beverages

(76) Inventor: Shane Robert McGill, Kent (GB)

Correspondence Address: NIXON & VANDERHYE, PC, 901 NORTH GLEBE ROAD, 11TH FLOOR, ARLINGTON, VA, 22203, US

(21) Appl. No.: 12/600,739

(22) PCT Filed: May 16, 2008
(86) PCT No.: PCT/GB08/01690

§ 371 Date: Jan. 15, 2010

Related U.S. Application Data
(60) Provisional application No. 60/938,762, filed on May 18, 2007.

(30) Foreign Application Priority Data
May 18, 2007 (GB) 0709571.4
Apr. 4, 2008 (GB) 0806207.7

(51) Int. Cl. A23G 9/04; A23L 2/00

(52) U.S. Cl. 426/565; 426/495; 426/393; 426/590

(57) ABSTRACT

A method of preparing a pre-blended beverage ingredient for use in the preparation of chilled beverages includes the steps of placing ice cubes or other pieces of solid ice together with a volume of liquid in a blending apparatus having vessel for receiving product to be blended and an impeller or other mixing or blending means arranged for high speed blending of product within the vessel, and then blending the ice within the liquid to produce a mixture of chilled liquid and a soft paste-like substance. The ice is substantially immersed in said volume of liquid prior to blending and any excess liquid is strained from the paste after blending.

The present invention relates to an ingredient for use in the preparation of a chilled beverage such as a milkshake or a smoothie, and also to a method and apparatus for preparing and/or storing the same, as well as methods for preparing beverages including said ingredient.

Ice is often used in the preparation of cold or chilled beverages. For example, it is known to combine ice cubes, crushed ice or shaved ice with other beverage ingredients.

Problems occur when it is desired to blend a mixture of beverage ingredients including ice, for example when using a conventional food blending apparatus or a blending arrangement of the types shown in the applicant's published International Patent Applications WO9921466, WO2005/013787 or WO2007057671 (the contents of which are incorporated herein by reference).

Ice cubes are one of the most difficult type of ice from which to obtain a blended beverage of smooth consistency. This is because partially blended ice cubes or ice cube type pieces can become stranded outside of the active blending zone of the impeller, so as to remain substantially unblended. Moreover, the blending of ice cubes or other solid pieces of ice is typically a noisy operation, which is not conducive to a retail environment, for example.

Crushed ice is not readily available as a standard product in conventional food serving outlets, and in any case is also prone to the same problems as ice cubes, albeit to a lesser degree. Shaved ice is far better for blending in beverages. However, there is often a reluctance to invest in the comparatively expensive apparatus required to provide shaved ice on demand.

Furthermore, it is often difficult to accurately measure the amount of conventional forms of ice that may be required for the preparation of a blended beverage, in particular for a single serving of milkshake or smoothie. This can lead to significant wastage, as well as delays in preparation time. Moreover, this may lead to variations in quality of the blended product, meaning that a standardisation of product quality, as desired by most product sellers, is unachievable.

An object of the invention is to provide an alternative chilled ingredient for use in the preparation of chilled beverages, e.g. milkshakes, slushes and smoothies.

According to a first aspect of the invention, there is provided an ingredient for use in the preparation of a chilled beverage, wherein the ingredient is obtainable from a mixture of ice and a volume of liquid which has been blended together (and preferably strained after blending to filter off any excess liquid) to produce a preferably paste-like blended ice substance.

The blended mixture is preferably strained after blending, so as to filter off any excess liquid, and thereby maintain the integrity of the remaining blended ice substance.

The blended ice substance is preferably of a homogeneous or substantially homogeneous nature and is a wet product, including small pieces or micro crystals of ice which, it is presently believed, exist collectively on a phase transition barrier between a fully frozen state and a fully liquid state. It has been found that the paste-like substance will not re-freeze under normal storage conditions, possibly due to the heat latency of the ingredient (e.g. which is high in the case of water). Rather, it is believed that the blended ice paste remains in a semi-solid or semi-frozen state until heat ingress causes a transition to a fully liquid phase. This is a particular advantage over the forms of ice commonly used in the preparation of chilled beverages, such as ice cubes and shaved ice, which have a tendency to fuse together if stored in contact with one another.

The blending operation is carried out using an apparatus having a vessel and an impeller arranged for high speed processing of product within the vessel, e.g. operating at speeds of typically at least 10000 rpm. The terms ‘blended’, ‘blending’ or similar, when used herein, should be construed accordingly. Importantly, it should be understood that conventional ice shavers are not within the scope of the apparatus referred to above, not least because the skilled person would appreciate that conventional ice shavers are not equipped with impellers for high speed food blending.

The ingredient relies on the use of the liquid to create a vortex within the blending vessel, thereby providing a medium for facilitating blending of the ice pieces by the impeller. The liquid acts as a means of moving the ice pieces and particles quickly and easily within the vortex formed within the blending vessel, to allow the blending blades to efficiently blend the ice pieces to generate the final small or micro particles that form the preferably paste-like blended ice substance.

Importantly, it should be understood that the simple act blending ice cubes, crushed ice or ice shavings in isolation (i.e. in the absence of a separate volume of liquid) will not result in a vortex and so will not result in the ingredient of the invention. Hence, the ingredient is preferably derived using a volume of liquid which is prepared or otherwise derived independently of the ice, e.g. from a tap or other source. That is to say, the volume of liquid is preferably not a direct by-product of the ice intended for use in the blending operation. The volume of liquid required for the blending operation (in order to facilitate a vortex containing the ice pieces) can be found by trial and error and/or using thermodynamic calculations. Suffice to say that the volume of liquid required for vortex conditions for blending of the ice is over and above the degree of melted ice that may be expected when leaving ice in non-refrigerated conditions for a short period of time, e.g. when transferring the ice from cooled storage to a blending location.

The liquid for the mixture is preferably water, although it may be preferred to use a solution having a freezing point less than that of water, i.e. less than zero degrees Celsius.

The ice for the mixture is preferably in the form of ice cubes or pieces of solid ice, e.g. prepared by freezing water or a solution having a lower freezing point than water.

More preferably, the first aspect of the invention relates to a pre-blended beverage ingredient (made of ice) for use in the preparation of a chilled beverage. That is to say, the ingredient undergoes a first blending operation prior to its addition to other beverage ingredients.

The pre-blended beverage ingredient can be stored for a period of time until it is needed as an ingredient in a chilled beverage. For example, the pre-blended ingredient can be transferred from the initial blending vessel to a separate storage vessel, wherein it is preferred if the storage vessel has a drainage facility to enable any excess liquid or melted ice to drain away from the preferably paste-like blended ice substance over time.

The use of a pre-blended ingredient is of particular advantage in the dispensing of chilled beverages in a commercial environment, such as in fast-food outlets and the like. For example, the pre-blended ingredient can be prepared during non-selling periods and stored until required. The pre-blended ingredient can be added to other beverage ingredients prior to a further blending operation, e.g. to create a chilled smoothie or milkshake, wherein the pre-blended structure of the blended ice substance overcomes the noise problems common to blending operations using other forms of ice for beverages, such as ice cubes. Furthermore, the consistency of the pre-blended paste-like substance lends itself to the production of blended beverages having a repeatably smooth consistency, not always possible when using conventional ice pieces in the beverage blending operation. In comparison, if conventional ice cubes, crushed ice or ice shavings are blended within ingredients that thicken up during blending, then the subsequent vortex of the blending operation will be reduced, making it difficult, if not impossible, to produce the form of smooth blended product that can be achieved when blending the same ingredients with the pre-blended beverage ingredient of the invention.

The pre-blended beverage ingredient is ideally suited for the ‘on demand’ preparation of freshly blended beverages, e.g. milkshakes or smoothies made by blending an ice-type ingredient with one or more other food ingredients. Tests have shown that the preparation time using the ingredient may be significantly shorter than for similar chilled beverages made using solid ice pieces or ice shavings, e.g. in the order of 20-40 seconds shorter. The reduction in blending time using the pre-blended beverage ingredient is not only advantageous from a service perspective, it also reduces the level of heat generated during the preparation of a chilled blended beverage than would otherwise occur under longer blending times.

The nature of the blended ice ingredient also lends itself to more accurate measurement than is possible using conventional ice cubes etc, e.g. when preparing a single portion of milkshake, since a volume of the ingredient can be readily metered, e.g. using a scoop or a manually- or automatically-operated mechanical dispensing mechanism (such as an Optic®-type device common in the field of dispensing of alcoholic beverages, or a screw type dispenser).

The pre-blended beverage ingredient is particularly suited for the preparation of freshly blended beverages, such as milkshakes, slushes and smoothies, using single use plastic blending lids of the kind described and illustrated in the applicant's published International Patent Applications WO9921466, WO2005/013787 or WO2007057671 (the contents of which are incorporated herein by reference), which are generally unsuitable for blending operations using conventional ice cubes.

According to a second aspect of the invention, there is provided a method of preparing a pre-blended beverage ingredient for use in the preparation of chilled beverages, the method including the steps of placing ice cubes or other pieces of solid ice together with a volume of liquid in a blending vessel and then blending the ice and liquid within the vessel to produce a mixture of chilled liquid and a preferably paste-like, blended ice substance.

The result of the method is a preferably paste-like blended ice substance of the kind referred to in the first aspect of the invention, i.e. having small pieces or micro crystals of ice which, it is presently believed, exist collectively on a phase transition barrier between a frozen state and liquid state, and wherein the ingredient will not re-freeze under normal storage conditions. As such, the product of the second aspect of the invention has the same benefits as the ingredient of the first aspect of the invention, as described in detail above.

As mentioned previously, the ingredient relies on the use of the liquid as a medium for facilitating the blending of the ice, whereas the simple act of blending ice cubes, crushed ice or ice shavings in isolation (i.e. in the absence of a separate volume of liquid over and above the degree of melted ice that may be expected when leaving ice in non-refrigerated conditions for a short period of time) will not produce a vortex required to blend the ice.

Preferably, the chilled liquid is strained from the mixture after blending, so as to maintain the integrity of the blended ice substance. Preferably, the straining takes place as soon as possible after blending, in order to delay the transition of the blended ice substance to a liquid.

In a preferred method, the ice and liquid is blended together and then the blended mixture is transferred to a filtering receptacle having a chamber for receiving the blended mixture, wherein excess chilled liquid is free to drain away from the blended ice substance, e.g. to a separate chamber of the receptacle, in order to maintain the integrity of the blended ice substance. The filtering receptacle preferably serves as a storage vessel for the blended ice product, prior to its use in a beverage producing operation.

The blending operation of the ice and liquid may take place in a standard blending vessel/jug, for example on a conventional domestic or industrial food processing appliance having a blending vessel of smooth-curved or generally circular internal profile. However, in a preferred method, the ice and the volume of liquid is loaded into a blending vessel (preferably of jug-type construction, including a handle) having an angular internal profile. The side walls of the vessel preferably define at least one deflector region for deflecting ice pieces into the active blending zone of the impeller.

The use of a blending vessel having an angular internal profile has been found to be particularly useful in directing solid pieces of ice towards the active blending zone of the impeller during a blending operation, whereas blending in conventional blending jugs having a generally circular or substantially curved internal profile can lead to ice pieces becoming stranded outside of said active blending zone, e.g. as a result of the vortex effect of a high speed blending operation.

In order to overcome the problems of ‘stranding’ referred to above (in isolation from or in addition to the use of an ‘angular’ blending vessel), the method of preparing the pre-blended ingredient preferably includes the use of a pulsed blending operation, wherein the ice and liquid is blended at high speed for a first blending period and then is allowed to stand for a predetermined time period before blending again for a second time period. By interrupting the blending operation in this way, partially blended product which has been thrown upwards and/or outwards from the active blending zone during the first blending period is free to fall back to the active blending zone for a subsequent blending period. The blending operation preferably includes at least one such interruption and the duration of the respective blending periods can be constant or varied, dependent upon the nature of the ice to be blended and the anticipated rate of breakdown of the ice over time during blending. Typically, the duration of the blending periods will increase after each interruption, as the product is broken down. The relative duration of the blending periods and interruptions required to produce the preferably paste-like blended ice substance can be found by trail and error.

In a preferred embodiment, the blending vessel includes first and second level indicators, for indicating the respective preferred levels for the ice and liquid ingredients for the purpose of creating the pre-blended beverage ingredient. For example, for a given form of ice (e.g. ice cubes of known size, mass, temperature), the vessel may indicate a first preferred level to which a maximum amount of ice should be filled, and a second preferred level to which a volume of liquid (e.g. water at a known temperature) should be filled after ice has been loaded in the vessel to said first preferred level. The appropriate levels for various forms/types of the ice and liquid can be found by trial and error.

In a preferred embodiment, the level for the liquid is above the level for the ice, to ensure that there is an excess of liquid medium for the blending operation. Hence, in one method of producing the pre-blended beverage ingredient, it may be preferred to ensure that substantially all of the ice is immersed in the liquid prior to blending. Any excess liquid is preferably strained off immediately after the blending operation, in order to maintain the integrity of the blended ice substance. In one preferred method, ice is loaded in to the vessel and liquid is poured in to the vessel until substantially all of the voids between the ice are filled with the liquid.

The liquid for the mixture is preferably water or a solution having a freezing point less than that of water. The ice for the mixture is preferably a product of frozen water or a solution having a lower freezing point than water. The ice more preferably takes the form of solid ice pieces, e.g. in the form of conventional ice cubes of known shape or dimension.

According to another aspect of the invention, there is provided a method of producing a chilled blended beverage, including the steps of placing ice cubes or other pieces of solid ice together with a volume of liquid in a first vessel, using a blending impeller to blend the ice and liquid in the first vessel to produce a pre-blended mixture of chilled liquid and blended ice, filtering excess liquid from the pre-blended mixture to leave a pre-blended ice ingredient, storing the pre-blended ice ingredient for a period of time, removing a volume of the pre-blended ice ingredient from storage, combining the volume of the pre-blended ice ingredient with one or more other beverage ingredients in a container, and then carrying out a further blending operation to blend the pre-blended ice ingredient with said other ingredient(s) in order to produce a chilled blended beverage.

The pre-blended ice ingredient is preferably stored under conditions in which any excess liquid (e.g. melted by-product of the pre-blended ice ingredient) is free to drain away. The method preferably includes the step of transferring the pre-blended mixture from the first vessel to a storage vessel (separate from said first vessel), wherein the storage vessel is preferably configured to allow drainage of excess liquid away from the semi-frozen pre-blended ice ingredient.

The pre-blended ice ingredient is preferably a blended ice substance in accordance with the first aspect of the invention and/or made in accordance with the method of the second aspect of the invention.

Another aspect of the invention provides an apparatus for storing a chilled pre-blended ingredient, the apparatus comprising a main body having first and second chambers arranged in fluid communication with one another via a filter for filtering excess liquid from a mixture of blended ice and liquid loaded into the first chamber, for separation of liquid from the blended ice, so as to maintain the integrity of the ice product.

The separation is preferably achieved under gravity, e.g. with first chamber located above the second chamber. In one embodiment, the filter comprises the base wall (or a least a substantial part thereof) of the first chamber, so that liquid from product placed in to the first chamber is free to drain down to the second chamber.

The apparatus is particularly useful in the preparation and storage of a pre-blended beverage ingredient of the kind referred to above, wherein the pre-blended mixture of ice and liquid can be transferred to the first chamber without undue delay after blending of the mixture, such that any excess liquid in the pre-blended mixture is free to drain from the semi-frozen product, via the filter. Over time, liquid resulting from the transition of the ice paste from its semi-frozen state can then drain from the remaining ice paste.

The first chamber preferably includes a closure member which can be moved from a closed position to an open position in order to introduce product to the upper chamber. The closure is preferably slidable or pviotable between its open and closed positions, and preferably remains within the space envelope (in plan view) of the apparatus in its open and closed positions.

In a preferred embodiment, the main body of the apparatus is formed by injection moulding or blow moulding.

The side walls of the upper chamber preferably define a cavity for receiving insulating material, and is preferably supplied with the cavity filled with insulating material.

The apparatus may include a valve for dispensing liquid from the second chamber.

A mechanism for automatic metering of product from the first chamber may be included, for the purpose of avoiding human contact with product within the upper chamber (so as to reduce the risk of contamination). This may take the form of an Optic®-type device or a screw-type delivery device.

According to yet a further aspect of the invention, there is provided a method of producing a chilled beverage, the method including the step of placing one or more beverage ingredients in a container, the beverage ingredients including a pre-blended ice ingredient and one or more additional beverage ingredients, and the method further including the step of blending the ingredients in said container so as to create a blended beverage for dispensing.

The pre-blended ice ingredient is preferably prepared by high speed blending of ice in volume of liquid, as described above. Hence, it will be understood that the pre-blended ice ingredient is preferably of the kind set forth in the first aspect of the invention and/or of the kind made in accordance with the method of the second aspect of the invention, and/or of the kind that may be stored and drained in the apparatus of the further aspect of the invention.

In a preferred embodiment, the container is in the form of a drinks vessel having a lid which carries an impeller for blending said ingredients in the container, e.g. of the kind described and illustrated in the applicant's published International Patent Applications WO9921466, WO2005/013787 or WO2007057671 (the contents of which are incorporated herein by reference). More preferably, one or more of the beverage ingredients, but excluding the pre-blended ice ingredient, is pre-packed in the container at a location which is remote from the dispensing location. The pre-packed ingredient can be sealed within the container by a heat sealed membrane or other removable closure by means of which a user can access the pre-packed ingredients on demand. The pre-packed ingredient(s) preferably includes a hydrated beverage powder formula and/or a liquid. In the case of a liquid ingredient, this is preferably filled under aseptic conditions (hot or cold), and may preferably be stored in ambient, chilled or frozen conditions. The composition of the pre-packed ingredients is preferably selected such that a blended beverage can be prepared within the container by removing the closure, applying a volume of the pre-blended ice ingredient to the other ingredients, enclosing said pre-packed and pre-blended ingredients in the container using a blending lid and blending the enclosed ingredients together, without the need for additional ingredients. However, additional ingredients (e.g. fruit pieces or flavourings) may be added together with the pre-blended ice ingredient, as desired.

According to another aspect of the invention, there is provided a method of producing a chilled blended beverage, the method including the steps of pre-packing one or more beverage ingredients in a container in the form of a disposable drinks vessel wherein the beverage ingredients are sealed in the container by a removable closure, transporting said pre-packed container to a retail location, storing said the beverage ingredients at said retail location, removing said removable closure from the container so as to access the pre-packed ingredients within the container, adding a volume of pre-blended ice to said pre-packed ingredients and blending the pre-packed ingredients with the pre-blended ice to create a chilled blended beverage for dispensing.

The pre-blended ice ingredient is preferably made in accordance with the method of the second aspect of the invention, and/or is a pre-blended ingredient in accordance with the first aspect of the invention.

Blending of the ingredients within the container is preferably achieved using a lid for the container which carries an impeller for blending ingredients in the container. Hence, the method preferably uses a blending or mixing apparatus of the kind described and illustrated in the applicant's published International Patent Applications WO9921466, WO2005/013787 or WO2007057671 (the contents of which are incorporated herein by reference).

According to a further aspect of the invention, there is also provided a kit for the preparation and storage of a pre-blended beverage ingredient, the kit including a blending vessel and an impeller arranged for blending a quantity of ice with a volume of liquid within the vessel, and a storage vessel for receiving the blended product from the blending vessel.

Preferably, the storage vessel is in accordance with the one or more aspects of the apparatus referred to above.

The blending vessel may be wholly conventional or may be in accordance with any of the blending vessels or jugs referred to in the method of the second aspect of the invention.

The kit may include a blender unit, e.g. a base unit for receiving said blending vessel, and configured for high speed operation of the impeller, so as blend ingredients in the blending vessel using said impeller.

According to a further aspect of the invention, there is provided a blending vessel for the preparation of a pre-blended ice ingredient for beverages, the blending vessel having one or more features of the blending vessels referred to in the method of the second aspect of the invention.

According to another aspect of the invention, there is provided drinks vessel, preferably a disposable beaker, more preferably of plastic material, for use as part of an apparatus for preparing a blended beverage, wherein the beaker has an open end and includes an annular internal shoulder spaced from its open end and arranged for seating a blending lid inside the open end of the beaker, wherein the beaker defines an annular wall extending up from said shoulder, and wherein an inwardly directed circumferential projection is provided in said wall for sealing cooperation with a blending lid when the lid is seated on the shoulder.

The shoulder is preferably provided at a depth of between 5 and 40 mm from the open end of the vessel.

The vessel preferably includes a further annular shoulder above its base, and a removable closure for cooperation with said further shoulder, in order to seal beverage ingredients within a lower region of the vessel.

Other aspects and features of the invention will be readily apparent from the appended claims and the following description of preferred embodiments, made by way of example only, with reference to the accompanying drawings, in which:

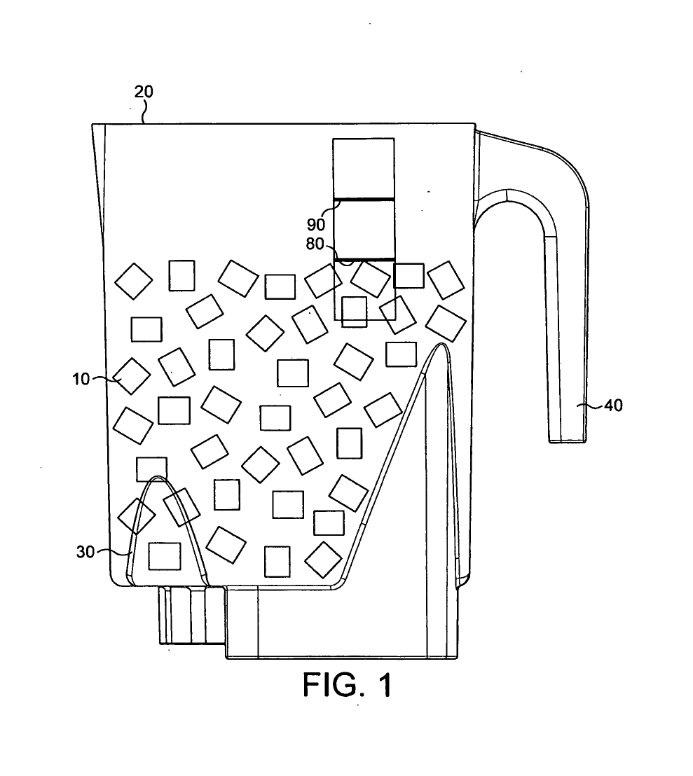

FIG. 1 is schematic part cross-sectional side view of a blending jug for use in creating a pre-blended beverage ingredient, wherein ice pieces have been loaded into the jug to;

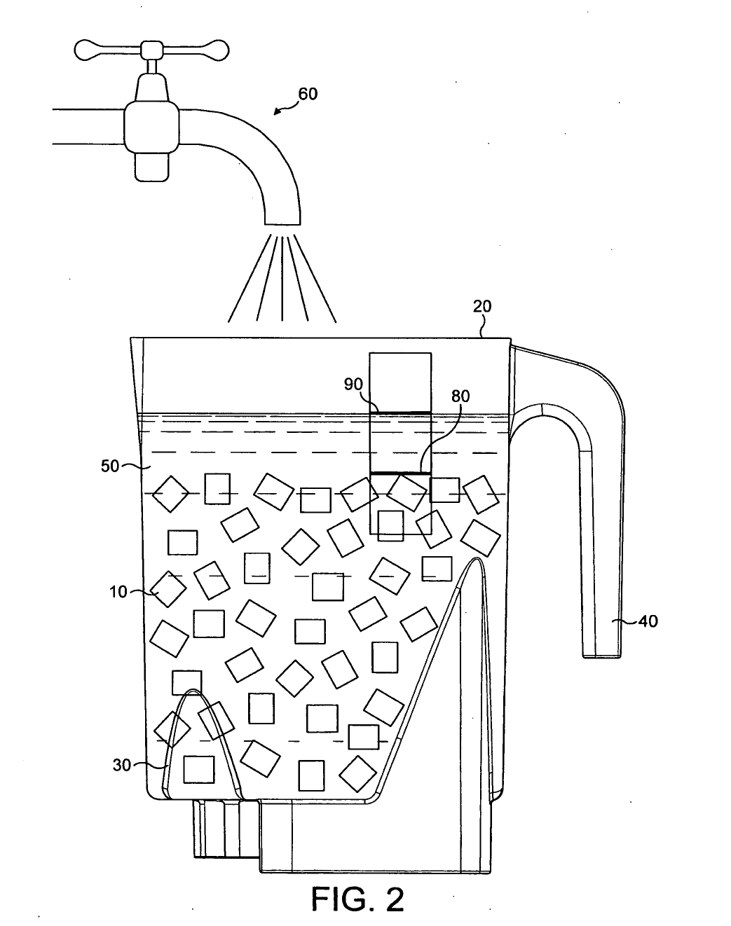

FIG. 2 is similar to FIG. 1 and shows the addition of water to the quantity of ice in the jug;

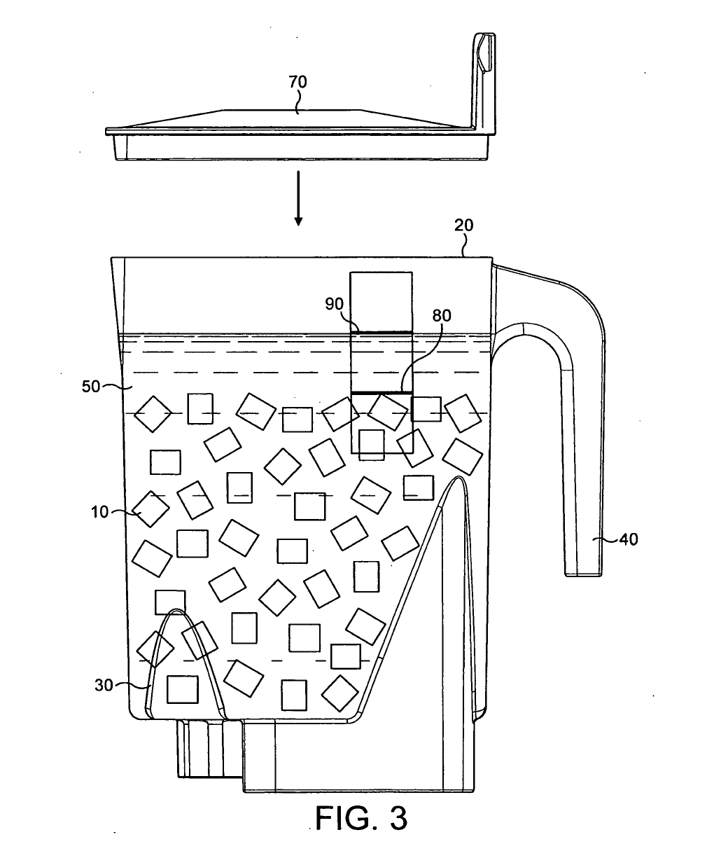

FIG. 3 is similar to FIG. 1 and illustrates the application of a lid for the jug, for the purpose of a pre-blending operation;

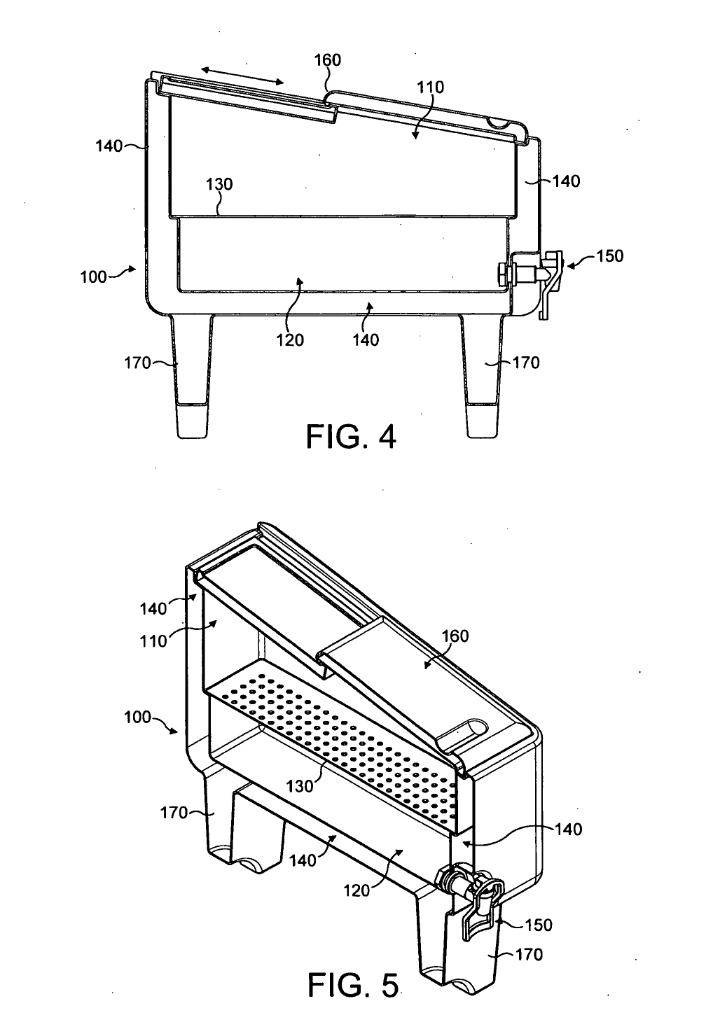

FIG. 4 is a schematic cross-sectional view through a chest for making and storing a pre-blended beverage ingredient;

FIG. 5 is a perspective view of the chest in FIG. 4;

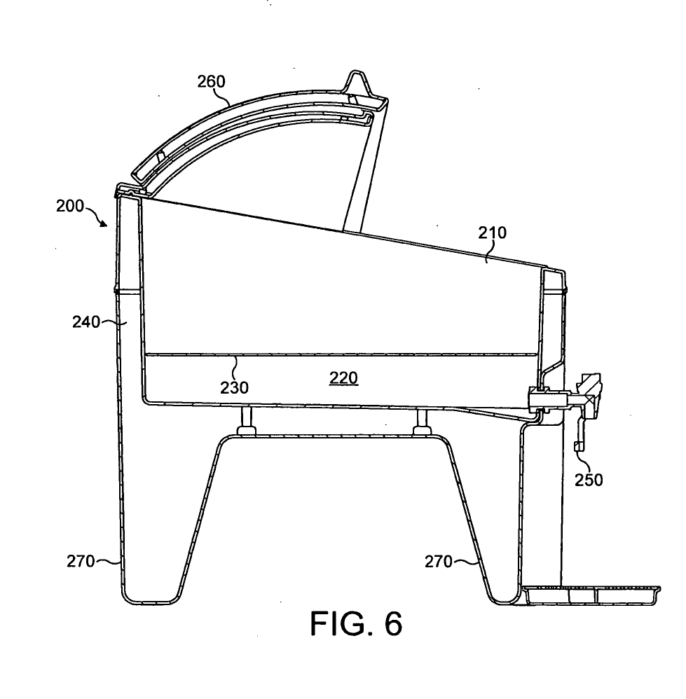

FIG. 6 is a schematic cross-sectional view through a further chest for making and storing a pre-blended beverage ingredient;

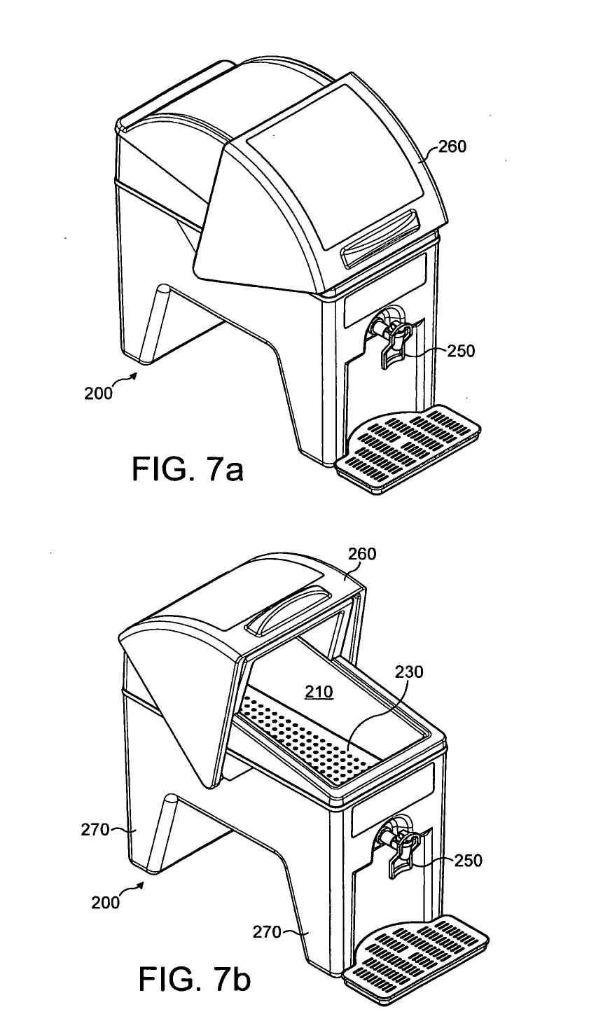

FIG. 7a is a perspective view of the chest in FIG. 6 with the lid closed;

FIG. 7b is similar to FIG. 7a and shows the lid open;

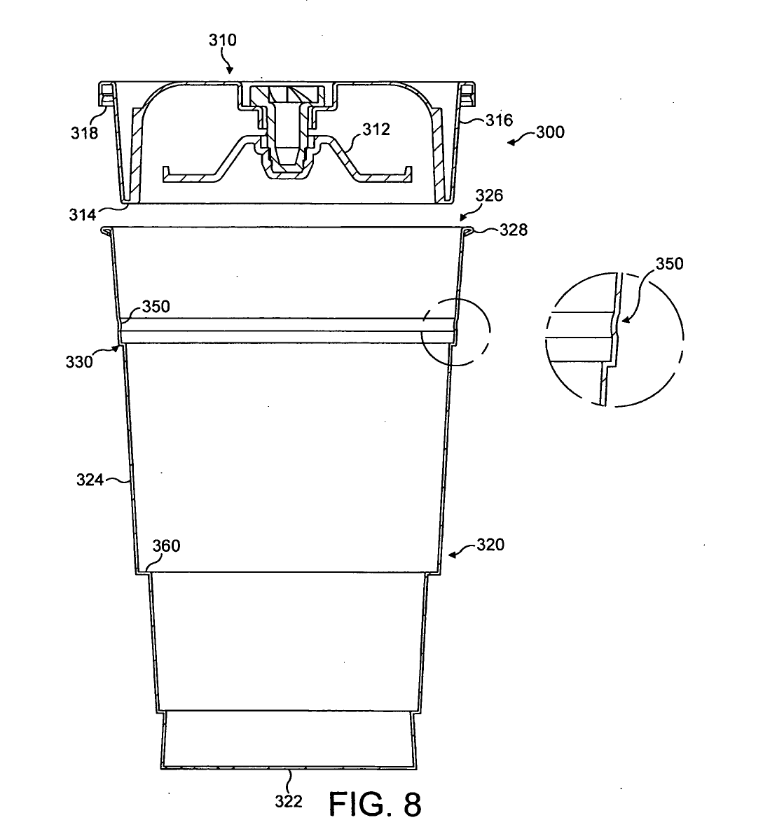

FIG. 8 is a schematic cross-sectional view of a preferred container and blending lid for use in preparing a blended beverage;

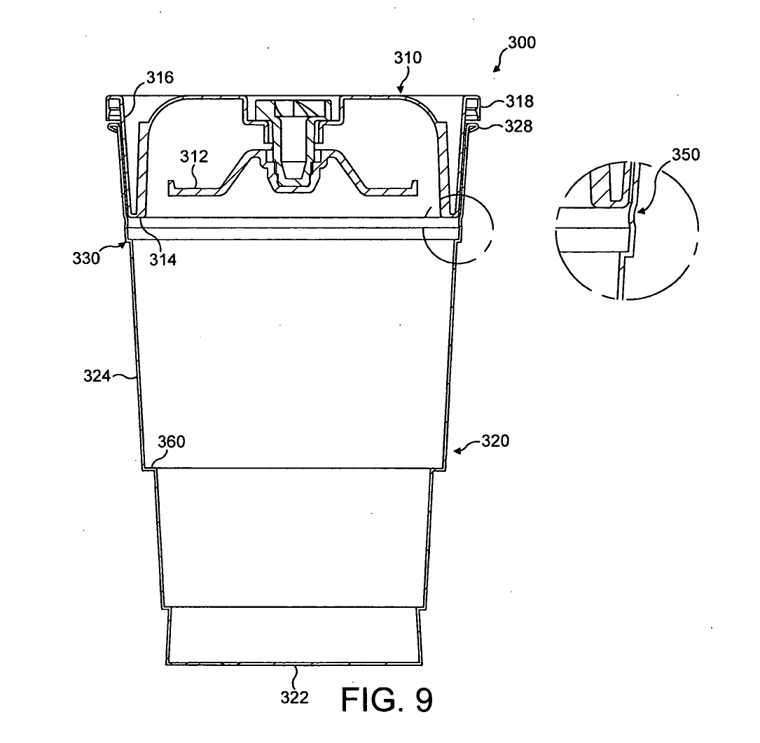

FIG. 9 is similar to FIG. 8 and shows the lid in a partially assembled state on said container; and

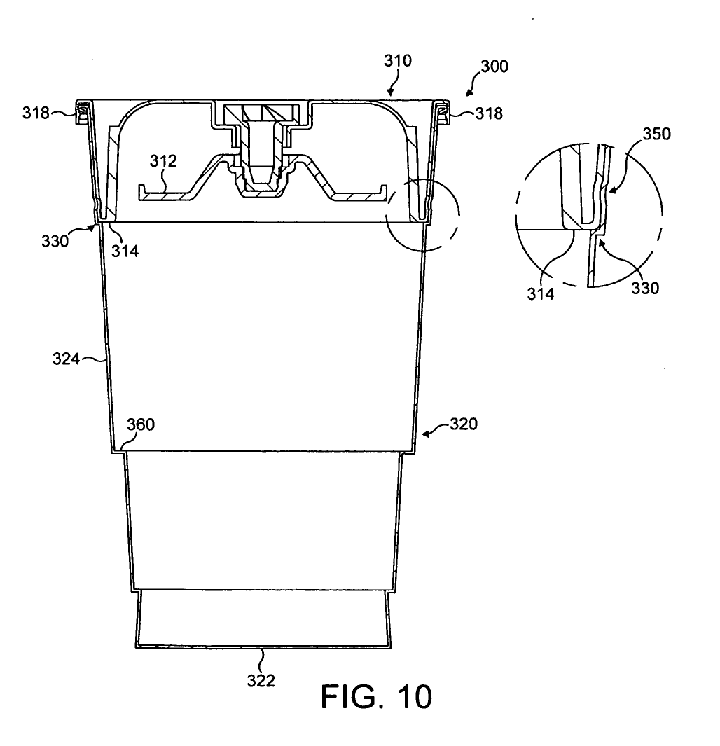

FIG. 10 is similar to FIGS. 8 and 9 and shows the lid in a fully assembled state on said container.

Referring firstly to FIG. 1, a chilled, pre-blended ingredient for use in beverages is prepared according to a preferred method by placing ice cubes or other pieces of solid ice 10 in a jug 20 having a handle 30 and an impeller 40 arranged for high speed rotation (e.g. when placed on a conventional blender base unit having drive means for operative connection with said impeller, whether direct or indirect) for blending product within the jug 20. As such, the jug may be of conventional form or may be replaced with other conventional food processing vessels configured for high speed blending of food product via an impeller or other form of mixing or blending means.

As indicated in FIG. 2, liquid 50, such as water from a tap 60, is combined with the ice 10 in the jug 20. As indicated in FIG. 3, a lid 70 is then applied to seal the ice 10 and liquid 50 in the jug 20. The impeller 30 is then operated in order to blend the ice 10 in the liquid 50, until the result is a preferably paste-like blended ice substance, preferably of substantially homogeneous nature. The paste is essentially a wet-to-touch product and, in most cases, the blending operation will result in said paste and a volume of excess chilled liquid.

An important aspect is the use of a liquid (e.g. water) as a medium for the blending of the ice, wherein it is presently believed that the liquid allows the ice pieces to move freely in suspension, so as to create a vortex during blending. In the absence of the liquid, the act of blending ice on its own (i.e. in the absence of a volume of liquid at least over and above the degree of melted ice that may be expected when leaving ice in non-refrigerated conditions for a short period of time, e.g. when transferring the same from cooled storage to a dispensing location) will not create the vortex required to produce a paste-like substance.

When using water as the blending medium, together with ice produced by freezing water, the ice particles which comprise the resulting paste will have absorbed heat/energy from the surrounding water during the high turbulence of the blending process. At least initially after blending, it is believed that the paste has a temperature of approximately zero degrees Celsius (the resultant chilled water may be a slightly warmer temperature than the ice paste). Instead of using water for the blending operation, it may be preferred to use a solution having a freezing point lower than that of water, for example a solution of water and sugar, in order to produce a lower temperature paste and chilled liquid.

An important point to note is that, after blending, the paste remains in a semi-frozen state, wherein a significant amount of energy would need to be extracted in order to convert the semi-frozen paste particles back to a solid frozen state. As such, the paste is unable to re-freeze under normal storage conditions and so remains in its paste-like state until such time as it changes to its liquid state, e.g. as a result of heat ingress during storage. This is in contrast to conventional crushed ice particles or ice shavings, which are prone to fusion. It is preferred if the paste is stored where adequate straining or drainage is possible, so that any excess liquid is free to drain away from the semi-frozen product.

Although the blending operation of the ice and liquid may take place in a standard blending jug, for example on a conventional domestic or industrial food processing appliance, in a preferred method the ice and the volume of liquid is loaded into a blending jug having an angular internal profile, as opposed to a conventional curved internal profile. It will be understood that high speed operation of the impeller creates a vortex of product within the jug. The use of a blending jug having an angular internal profile has been found to be particularly useful in directing solid pieces of ice towards the active blending zone of the impeller during blending, whereas a vortex created in a conventional blending jug having a generally circular or substantially curved internal profile may more readily allow for stranding of the ice pieces outside of said active zone.

In order to overcome the problems of stranded ice pieces referred to above, the method preferably includes the use of a pulsed blending cycle (which may be in addition to the use of an ‘angular’ blending jug), wherein the impeller is caused to rotate at high speed for a first blending period and is then stopped for a predetermined time period, before repeating the first blending period or operating the impeller for a second time period (i.e. of different length to said first time period). By interrupting the blending cycle in this way, partially blended product which has been thrown upwards and/or outwards from the active blending zone during the first blending period can be allowed to fall back to the active blending zone, ready for a subsequent blending period. The blending cycle preferably includes at least one such interruption.

It is preferred if the blended mixture is filtered or otherwise strained immediately after the desired period of blending, in order to separate any excess chilled liquid from the ice paste. This maintains the integrity of the ice paste product, meaning that, as is presently believed, the ice paste can exist on a transition barrier between a pure solid and a liquid for longer.

In one method, a predetermined amount of ice 10 and a correspondingly predetermined amount of water 20 is loaded into a blending jug 30, ready for blending. The amount of liquid used in the blending operation may be selected so as to produce a suitably blended ice paste which does not require immediate straining (e.g. wherein there is little or no excess water immediately after blending). However, as will be described below, it may be preferable to store the paste in a container which includes drainage means, whereby any melted paste is free to flow out from the body of stored semi-frozen product.

In another method, a blending jug or other blending vessel is loaded to the top with solid ice pieces (e.g. conventional ice cubes) and then water or other liquid solution is poured in to the vessel to fill the spaces between the ice pieces, prior to blending.

The respective amounts of ice and liquid required for preparing the pre-blended paste like ingredient can be arrived at by trial and error, taking in to account various factors, such as the size, configuration and temperature of the ice, as well as the type of liquid used to create the ice and the type and temperature of the liquid intended for the blending operation.

In the illustrated embodiment of FIGS. 1 to 3, a wall of the blending jug 20 includes first and second markers 80, 90, wherein the first marker 80 indicates the level to which a maximum amount of ice 10 of a known form should be filled, and the second marker 90 indicates the level to which a volume of liquid 50 (e.g. water at a known temperature) should be filled when the ice 10 has been loaded in the jug 20 up to the first marker 80. As can be seen, the marker for the liquid 50 is above the marker for the ice 10, thereby ensuring that there is sufficient liquid medium for the blending operation, wherein any excess liquid can be strained off immediately after the blending operation. However, a liquid marker may be provided above or below the ice marker for other forms or sizes of solid ice pieces, wherein the level of the respective markers can be realised by trial and error.

It is most preferred if the blended mixture is loaded into a chest or other container for storage immediately after blending, wherein the container preferably includes drainage means to enable any excess water to flow away from the stored paste. In a preferred method, the mixture is fed into a chest or container of the kind indicated generally at 100 in FIGS. 4 and 5.

The chest 100 defines an upper chamber 110 into which the mixture is placed and a lower chamber 120 for receiving excess chilled liquid from the mixture. A filter 130 is provided between the upper and lower chambers 110, 120, for separating the paste from the chilled liquid, e.g. under gravity. In this embodiment, the filter 130 sits on a ledge within the main body of the chest 100 and defines the base of the upper chamber 110.

The paste is preferably separated from the chilled liquid as quickly as possible, to prevent the ice paste from absorbing heat from the chilled water, which would otherwise melt the ice. Hence, the mixture should be transferred to the chest as quickly as possible after blending.

Once the paste has been drained of the chilled liquid, it remains in its semi-frozen state in the upper chamber 110 of the chest 100 for an initial period of time. Of course, a percentage of the paste will melt and pass down through the filter 130 into the lower chamber 120 as chilled liquid, due to thermal transfer through the walls of the chest 100 for example. However, this is a slow process and under normal operating conditions the paste should remain in its semi-frozen state for a reasonable amount of time, e.g. several hours. Preferably, the paste is stored under filtering conditions, wherein any melt liquid is free to drain away from the body of semi-frozen product.

The illustrated chest 100 is formed by blow moulding and has hollow walls so as to define a cavity 140 around the upper and lower chambers 110, 120. The cavity can be filled with an insulating foam or other insulating material, to resist thermal transfer through the walls of the chest 100.

The lower chamber 120 includes a dispenser 150, e.g. a faucet, for dispensing the chilled liquid from the chest 100. Upper chamber acts as a chiller for the chilled water in the lower chamber. The chilled liquid can then be reused in a subsequent paste blending process or for other beverage applications, for example.

The chest 100 has a sliding lid 160, which can be opened and closed in the direction of the arrows in FIG. 4. The sliding lid 160 is advantageous in that the chest can be accommodated close to the underside of filling device, for example, which would not be the case if the closure was hinged. Furthermore, the lid 160 shown in FIGS. 4 and 5 is configured so that it remains within the envelope defined by the chest 100 in plan view when it is moved to its fully open position. Hence, the chest can be arranged with the left-hand end as viewed in FIG. 4 located against or adjacent a wall or like surface. Alternatively, the lid 160 may slide in the opposite direction (i.e. to the right as viewed in FIG. 4). However, the lid 160 may be hinged, rather than slidable.

The lid 160 is preferably of hollow and/or blow moulded construction, and so may incorporate insulating material. Cold air (being heavier than warm air) should remain on top of the paste, thus only allowing minimal heat ingress when the lid 160 is opened.

The chest 100 is mounted on feet 170 to raise it high enough to suit the size of the receptacle(s) to be placed below the chilled water outlet 150.

In other embodiments, the chest may be fabricated or injection moulded, wherein insulation may be applied internally or externally. An example is shown in FIGS. 6 and 7, the storage vessel being indicated at 200, with corresponding components having the same reference numerals as the chest 100, albeit with the prefix 2______. It should be noted that the dispenser in the embodiment of FIGS. 6 and 7 is of push-type construction (movable from left to right as viewed in FIG. 6, under the application of pressure).

In a preferred embodiment, one or more low temperature eutectic plates (not illustrated) can be provided within the chests 100, 200 (e.g. in the chambers 110, 120 and/or lid 160) to assist in the maintenance of the required temperature inside the chests 100, 200.

The paste can be metered or served by volume in an accurate manner, e.g. using a manual scoop for loading into a blending receptacle, such as containers of the kind shown in the applicant's published International Patent Applications WO9921466, WO2005/013787 or WO2007057671 (the contents of which are incorporated herein by reference). The scoop preferably includes a shield portion for a user's hand, wherein the shield portion is configured to reduce the risk of manual contamination of the ice paste, when using the scoop. The scoop may include drainage apertures for the drainage of melt liquid from the paste. In an alternative embodiment, the chest includes a mechanism for manual or automated dispensing of paste from storage, e.g. A conventional Optic®-type device or a screw-type delivery device, or any other suitable device of known form.

The paste can be readily blended with other ingredients to produce a beverage of a smoother consistency than is typically achievable using ice cubes or crushed ice.

The blending time required to produce a smooth beverage can be greatly reduced, since the ice has already gone through a pre-blending stage in order to form the paste. Hence, the paste can be produced during non-busy selling periods so that the blending time during busy periods is greatly reduced. The noise level created when blending a beverage using the paste is also much lower than would otherwise be the case when blending solid pieces of ice such as ice cubes.

In a preferred method of dispensing a chilled beverage, one or more beverage ingredients are loaded into a container, the beverage ingredients including a volume of pre-blended ice paste of the kind described above and one or more additional beverage ingredients, are blended together to create a blended beverage for dispensing.

The container may be a conventional blending vessel, but is preferably in the form of a drinks vessel having a lid which carries an impeller for blending said ingredients in the container, e.g. of the kind described and illustrated in the applicant's published International Patent Applications WO9921466, WO2005/013787 or WO2007057671 (the contents of which are incorporated herein by reference). Hence, the blended beverage can be consumed directly from the container after blending, e.g. using a straw through the lid or by drinking from an open end of the container.

More preferably, one or more of the additional beverage ingredients, but excluding the pre-blended ice ingredient, are pre-packed in the container at a location which is remote from the dispensing location. The pre-packed ingredient(s) preferably includes a hydrated beverage powder formula, but may also include a pre-packed liquid ingredient. The containers can be stacked or otherwise stored at the packing location and transported to a blending location (e.g. a fast food or retail outlet), ready for selection by a customer. In order to prepare a beverage, a volume of the pre-blended ice paste is added to the pre-packed ingredient in the container (together with one or more additional ingredients, if desired, e.g. chilled liquid from the ice paste, milk, fruit juice and/or fruit or confectionery pieces), whereupon the lid is then applied to seal and blend the contents in the container.

FIGS. 8 to 10 show an apparatus 300 for dispensing blended beverages, the apparatus 300 having a blending lid 310 which carries a rotatable impeller 312, and a drinks vessel 320. It will be understood that the impeller is rotatably drivable via separate drive means external to the apparatus 300, for example substantially as described in the applicant's International Patent Applications WO 2005/013787 or WO 2004/002281, which are incorporated herein by reference. As such, it is preferred if the apparatus is inverted for the purpose of a blending operation, such that the lid 310 is lowermost.

The drinks vessel 320 is in the form of a beaker, most preferably a plastics item, having a base 322 and tapering side walls 324 which extend to an open upper end 326. An outwardly directed lip 328 is provided about the open end.

As can be seen, a pronounced step region which defines an annular shoulder 330 is preferably provided at an upper region of the vessel 320. This shoulder 330 is specifically intended to serve as a seating for an underside portion 314 of the lid 310, as can be seen most clearly from FIG. 10. Moreover, the taper of the side walls 324 above the shoulder 330 is configured to match the taper of an outer wall 316 of the lid 310, so that the lid 310 can be nested in the upper end of the vessel 320, supported on the shoulder and in frictional engagement or approximate abutment with the internal surface of the vessel 320.

The depth of the shoulder 330 is preferably selected to match the depth of the lid 310, so that the two items are preferably configured specifically to be united with one another, with the out-turned rim 318 of the lid 310 engaged over the lip 328 of the vessel 320 when the underside portion 314 of the lid 310 is in abutment with the shoulder 330.

In this embodiment, the shoulder 330 is provided at a depth of approximately 30 mm from the open end of the container, markedly spaced from the open end of the container and wholly distinguished from the rim of the container. On other embodiments, the shoulder 330 may be located at a depth of 5 mm to 15 mm, 15 mm to 25 mm, or 25 mm to 35 mm, for example.

The provision of the shoulder 330 at a depth which matches the depth of a blending lid intended to be received inside the open end of the container is advantageous in that it provides a convenient means for user to readily detect whether the lid 310 has been correctly located on the vessel 320. Perhaps more importantly, a first seal or barrier to leakage can be achieved between the step region of the vessel 320 and the lid 310, in addition to the seal or barrier which would typically be provided between the lid 310 and the lip 328 of the vessel 320. By ensuring that the taper of the internal surface 326 above the shoulder 330 matches the taper of the external wall of the lid 316, a sliding fit can be provided between the lid 310 and vessel 320, which acts as an axial leak-proofing, in addition to the seals provided at the lip 328 and shoulder 330.

In a preferred embodiment, the arrangement is such that after the lid 310 has been fitted over the lip 328 of the vessel 320, the underside portion 314 of the lid may be spaced from the shoulder 330, and wherein the rim 318 of the lid 310 defines a space above the lip 328 of the vessel, e.g. as shown in FIG. 9. A user may then apply pressure to the lid and/or vessel so as to bring the underside portion 314 of the lid 310 into abutment with the shoulder 330, as shown in FIG. 10.

More specifically, the side walls of the container define a circumferential and inwardly directed projection or dimple 350 above the level of the shoulder 330. In the absence of external pressure from a user or automated device, the dimple 350 prevents the lid from seating on the shoulder 330. The dimple 350 is configured to deform outwardly by downward movement of the lid 310 to its seated position on the shoulder 330, wherein the dimple 350 is radially biased into engagement with the contacting portion of lid 320, thereby providing a further seal against egress of product from beneath the shoulder of the container prior to, during or after blending.

The vessel preferably has a further shoulder 360 located towards at a lower region of the vessel 320, on to which a removable closure can be provided, e.g. a heat sealed membrane or removable insert, for pre-packing and sealing beverage ingredients in the container. In one embodiment, the vessel is pre-packed with a powdered beverage formulation, to which liquid and/or other beverage ingredients can be added, for blending within the vessel 320, in order to produce a blended beverage. In another embodiment, the vessel is pre-packed with a liquid ingredient. The pre-packed ingredients are preferably aseptically filled and sealed within the vessel, and may be transported at ambient temperatures (without refrigeration). In the case of a liquid pre-packed ingredient, this may be hot-filled and sealed within the vessel.

The beverage is produced by blending the pre-packed ingredients with a portion of the pre-blended semi-frozen ice ingredient described above (with or without additional ingredients) within the vessel, using the blending lid.

It is preferred if the vessel 320 is made from plastics material as a moulded item, which provides durability for resisting impact from material being blended within the vessel, for example solid ice material, in particular ice cubes. The plastics material is preferably of a kind and thickness which renders the vessel 320 readily disposable after a single use, but suitably robust to resist splitting upon an impact from product within the container during blending. However, paper containers can be used with a smaller plastic container as an insert inside the paper container. This smaller plastic container would be fixed inside the base of the paper container by heat-sealing, glue or by interference fit. The insert can be used to contain the pre-packed liquid to be sealed within the smaller container, complete with a removable protective cover. Use of the paper container may offer desirable environmental advantages.

The term disposable used in relation to the above embodiment should be understood to mean that the vessel is intended for use in a single beverage dispensing operation, wherein a beverage is blended in the vessel, the beverage is then consumed from the vessel, and the vessel is then disposed of and not reused for a subsequent blending operation. However, the material for the vessel may be recyclable.

1. A method of producing a chilled blended beverage, including the steps of placing ice cubes or other pieces of solid ice together with a volume of liquid in a first vessel, conducting a first blending operation using a blending impeller to blend the ice and liquid in the first vessel to produce a pre-blended mixture of chilled liquid and blended ice, filtering excess liquid from the pre-blended mixture to leave a pre-blended ice ingredient, storing the filtered pre-blended ice ingredient for a period of time, removing a volume of the filtered pre-blended ice ingredient from storage, placing said volume of filtered pre-blended ice ingredient in a container with one or more other beverage ingredients, and then conducting a further blending operation to blend the filtered pre-blended ice ingredient with said other ingredient(s) in order to produce a chilled blended beverage.

2. A method according to claim 1 wherein after the first blending operation the pre-blended ice ingredient is stored under filtering conditions in which excess liquid is free to drain away from the pre-blended ice ingredient.

3. A method according to claim 1 or claim 2, including the step of transferring the pre-blended mixture from the first vessel to a storage vessel configured to allow drainage of excess liquid away from the pre-blended ice ingredient.

4. A method according to any of claims 1 to 3 wherein the pre-blended ice ingredient is in the form of a soft paste-like substance, preferably of homogeneous or substantially homogeneous nature.

5. A method according to any of claims 1 to 4 wherein, prior to the first blending operation, the ice is fully or substantially immersed in said volume of liquid in said blending vessel.

6. A method according to any of claims 1 to 5 wherein the first blending operation is interrupted after a first blending period, to allow partially blended product to return to the active blending zone of the impeller, before the first blending operation is continued for a second blending period.

7. A method according to claim 6 wherein the further blending operation is carried out in a beverage container having a lid for sealing the product to be blended within the container, and wherein the impeller is mounted on the lid or in the base of the container.

8. A method according to claim 7 wherein the impeller is arranged for operative connection with drive means external to the container and lid, for causing high speed rotation of the impeller.

9. A method according to claim 7 or claim 8 wherein at least one of said other beverage ingredients for said further blending operation is pre-packed in the container.

10. A method according to claim 9 wherein the pre-packed ingredient includes a liquid which is hot-filled or otherwise aseptically packed and sealed in the container by a removable closure member.

11. A method of preparing a pre-blended beverage ingredient for use in the preparation of chilled beverages, the method including the steps of placing ice cubes or other pieces of solid ice together with a volume of liquid in a blending vessel, and using an impeller to blend the ice within the liquid to produce a mixture of chilled liquid and a blended ice product in the form of a soft paste-like substance, and wherein the chilled liquid is strained from the mixture after blending.

12. A method according to claim 11 wherein the ice and liquid is blended together and then the blended mixture is transferred to a filtering receptacle having a chamber for receiving the blended mixture, said chamber being configured to allow excess chilled liquid to drain away from the paste-like substance and out of said chamber.

13. A method according to claim 12 wherein the paste-like substance is stored in said filtering receptacle until required for a beverage dispensing operation.

14. A method according to any of claims 11 to 13 wherein the ice is substantially immersed in said volume of liquid prior to blending.

15. A method according to any of claims 11 to 14 wherein the liquid for the mixture is water or a solution having a freezing point less than that of water.

16. A method according to any of claims 11 to 15 wherein the ice for the mixture is a product of frozen water or a solution having a lower freezing point than water.

17. A pre-blended beverage ingredient made in accordance with the method of any one of claims 11 to 16.

18. A pre-blended beverage ingredient for use in the preparation of a chilled beverage wherein the ingredient is the product of a mixture of ice and a volume of liquid, which has been blended together in a vessel using an impeller rotated at high speed, and then strained so as to filter off excess liquid, thereby leaving a blended ice product, preferably in the form of a soft paste-like substance.

19. A blended beverage produced using a pre-blended beverage ingredient according to claim 17 or claim 18.

20. A blended beverage produced using a pre-blended beverage ingredient made according to the method of any of claims 11 to 16.

21. A method of dispensing a chilled beverage, the method including the steps of loading beverage ingredients into a container, the beverage ingredients including a volume of pre-blended ice and one or more additional beverage ingredients, and then blending the ingredients with the pre-blended ice to create a blended beverage for dispensing.

22. A method according to claim 21 wherein the pre-blended ice is made in accordance with the method of any of claims 11 to 16.

23. A method according to claim 21 wherein the pre-blended ice is a pre-blended ingredient in accordance with claim 17 or claim 18.

24. A method according to any of claims 21 to 23 wherein the container is in the form of a drinks vessel having a lid for sealing the product to be blended within the container, and wherein the impeller is mounted on the lid or in the base of the container.

25. A method according to any of claims 21 to 24 wherein one or more of the additional beverage ingredients is pre-packed in the container at a location which is remote from the beverage blending location, and wherein the pre-blended ice is added at the beverage blending location.

26. A method according to claim 25 wherein the pre-packed ingredient(s) include a hydrated beverage powder formula and/or a liquid ingredient, and which is accessible via a removable closure within the container, prior to addition of the pre-blended ice ingredient.

27. A method of dispensing a chilled blended beverage, the method including the steps of pre-packing one or more beverage ingredients in a container in the form of a disposable drinks vessel, wherein the beverage ingredients are sealed in the container by a removable closure, transporting said pre-packed container to a further storage location, storing said the beverage ingredients at said storage location, selecting said container from storage and removing said removable closure from the container so as to access the pre-packed ingredients within the container, adding a volume of pre-blended ice to said pre-packed ingredients and blending the pre-packed ingredients with the pre-blended ice to create a chilled blended beverage for dispensing.

28. A method according to claim 27 wherein the pre-blended ice is made in accordance with the method of any of claims 11 to 16.

29. A method according to claim 28 wherein the pre-blended ice is a pre-blended ingredient in accordance with claim 17 or claim 18.

30. A method according to any of claims 27 to 29 wherein the blending of the ingredients within the container is achieved using a lid for the container which carries an impeller for blending ingredients in the container.

31. Apparatus for storing a chilled pre-blended ice ingredient, the apparatus comprising a main body having first and second chambers arranged in fluid communication with one another via a filter for filtering excess liquid from a mixture of blended ice and liquid loaded into the first chamber, for separation of liquid from the blended ice, so as to maintain the integrity of the ice product.

32. Apparatus according to claim 31 wherein the main body is formed by blow moulding or injection moulding.

33. Apparatus according to claim 31 or claim 32 wherein the side walls of the first chamber define a cavity for receiving insulating material.

34. Apparatus according to claim 33 wherein the cavity is filled with insulating material.

35. Apparatus according to any of claims 31 to 34 wherein filter comprises a separating wall between the first and second chambers.

36. Apparatus according to any of claims 31 to 35 wherein said first chamber includes a volume of pre-blended beverage ingredient made according to any one of claims 11 to 18.

37. A method according to claim 4 or claim 12 wherein the filtering receptacle comprises an apparatus according to any of claims 31 to 36.

38. A disposable beaker for use as part of an apparatus for preparing a blended beverage, wherein the beaker has an open end and includes an annular internal shoulder spaced from its open end and arranged for seating a blending lid inside the open end of the beaker, wherein the beaker defines an annular wall extending up from said shoulder, and wherein an inwardly directed circumferential projection is provided in said wall for sealing cooperation with a blending lid when the lid is seated on the shoulder.

39. A beaker according to claim 38 wherein the shoulder is provided at a depth of between 5 and 40 mm from the open end of the beaker.

40. A beaker according to claim 38 or 39 wherein the beaker includes a further annular shoulder above its base, and a removable closure for cooperation with said further shoulder, in order to seal beverage ingredients within a lower region of the beaker.
